(19) United States
(12) Patent Application Publication
(10) Pub. No.: US 2026/0153111 A1
(43) Pub. Date: Jun. 4, 2026

(54) Furniture Assembly and Fasteners

(71) Applicants: NEXUS BERSATU SDN. BHD., MUAR (MY); ACT ENGINEERING SDN. BHD., BATU PAHAT (MY)

(72) Inventors: Yan Hua LEE, Muar (MY); Yi Hua LEE, Muar (MY)

(21) Appl. No.: 19/403,394

(22) Filed: Nov. 28, 2025

(30) Foreign Application Priority Data
Dec. 3, 2024 (MY) PI2024006926

(51) Int. Cl. F16B 12/14; A47B 55/00

(52) U.S. Cl. CPC F16B 12/14; A47B 55/00; A47B 2230/0051

(57) ABSTRACT

A fastener for use in connecting a plurality of components includes an elongate body having, in its longitudinal direction, a first section and a second section. The first section includes external threads configured to be screwed into a threaded hole of a first component, and the second section includes a plurality of serrated teeth configured to firmly engage with a hole of a second component.

### CROSS-REFERENCE TO RELATED APPLICATIONS

This application claims priority to, and the benefit of, Malaysian Patent Application No. PI2024006926, filed Dec. 3, 2024, the contents of which are incorporated by reference herein in their entirety.

### TECHNICAL FIELD

The invention relates to a furniture assembly. More particularly, the invention relates to a furniture assembly with means for conveniently connecting furniture panels without the need of tools during assembly.

### BACKGROUND

The process of assembling furniture plays a crucial role in the interior design and home furnishings sector. There are two main methods for delivering furniture to consumers, each with its own benefits and drawbacks. The first method involves delivering pre-assembled furniture. While this option offers the convenience of ready-to-use pieces, it also presents challenges. For instance, fully assembled furniture is costly to transport due to its size, and can be difficult to move through tight spaces like narrow doorways or up staircases, making delivery and setup more complicated.

The second method involves shipping furniture in a knockdown or flat-pack format, which has grown in popularity because it addresses the challenges associated with pre-assembled furniture. By breaking the furniture into smaller, more easily packaged components, transportation costs are significantly reduced, and the environmental impact is minimized. Additionally, moving flat-packed items within a home is much easier, as users can maneuver around tight corners and restricted areas with greater ease. However, this approach requires specialized connectors to enable a simple and tool-free installation of the furniture.

There are a few patented technologies over the prior art relating to these types of connectors. Of interest in respect to fastener for connecting components and assembling embodying same is US20080193209A1. This patent discloses a fastener element is adapted to be secured in a blind hole formed in a first component to be connected to a second component generally provided with an aligned blind hole. The element is of generally cylindrical shape with an outer surface provided with a series of anchoring formations following a generally helical path along at least a part of its length. The formations are configured to enable the element to be forcibly introduced, at least partially, without rotation thereof axially into a blind hole in said first component to anchor the element therein. The fastener element either has a shank permanently associated therewith or one or more formations for the operative retention of a cooperant end of a separate shank. The shank has an engagement zone whereby rotation of the element can be effected about its axis to result in axial movement of the element relative to the hole to tighten a joint. Nevertheless, a wrench or spanner is required for the installation or removal of the fastener.

Accordingly, it would be desirable to provide a furniture connector or assembly that can achieve tool-less installation. This invention provides such a connector and furniture assembly thereof.

### BRIEF SUMMARY

In a first aspect of the invention, there is provided a fastener for use in connecting a plurality of components, the fastener comprises an elongate body having, in its longitudinal direction, a first section and a second section; characterised in that the first section includes external threads configured to be screwed into a threaded hole of a first component, and the second section includes a plurality of serrated teeth configured to firmly engage with a hole of a second component.

Preferably, the elongate body may further include a third section having a frictional surface configured to be gripped by a user to facilitate the screwing motion of the first section onto the first component.

In this embodiment, a diameter of the second section may be larger than or about the same as the first section.

In this embodiment, the second section may be positioned between the first and third sections.

In this embodiment, the third section may be inserted into the hole of the second component along with the second section.

In this embodiment, the third section may be of a truncated cone shape that has a ridged base configured to firmly engage with the hole of the second component.

In this embodiment, the threaded hole may be in the form of a nut attached to the first component.

In this embodiment, the components may include panels and/or frame structures made of metal, plastic, wood or any combination thereof.

In a second aspect of the invention, there is provided a furniture assembly comprises a first component; and a second component connected to the first component via a fastener; wherein the fastener comprises: an elongate body having, in its longitudinal direction, a first section and a second section; characterised in that the first section includes external threads configured to be screwed into a threaded hole of a first component, and the second section includes a plurality of serrated teeth configured to firmly engage with a hole of a second component.

Preferably, the elongate body may further include a third section having a frictional surface configured to be gripped by a user to facilitate the screwing motion of the first section onto the first component.

In this embodiment, a diameter of the second section may be larger than or about the same as the first section.

In this embodiment, the second section may be positioned between the first and third sections.

In this embodiment, the third section may be inserted into the hole of the second component along with the second section.

In this embodiment, the third section may be of a truncated cone shape that has a ridged base configured to firmly engage with the hole of the second component.

In this embodiment, the threaded hole may be in the form of a nut attached to the first component.

In this embodiment, the furniture assembly may further comprise a third component connected to the second component via one or more second fasteners and/or one or more third fasteners.

In this embodiment, the second fasteners may be in the form of a dowel pin.

In this embodiment, each third fastener may comprise a plate body, and a pair of projections extending from one side of the plate body for insertion into holes of the second and third components respectively, wherein each projection comprises at least one tooth flange along a length of the projection, and a slot adjacent to the tooth flange.

In this embodiment, the furniture assembly may further comprise a fourth component connected to the first, second, and/or third components via a plurality of fourth fasteners.

In this embodiment, each fourth fastener may comprise a shaft body with a cap at one end of the shaft body and a plurality of teeth space along a longitudinal distance of the shaft.

In this embodiment, the components may include panels and/or frame structures made of metal, plastic, wood or any combination thereof.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a perspective view diagram illustrating an embodiment of a fastener.

FIG. 2a is a perspective view diagram illustrating a first example of the fastener in operation.

FIG. 2b is a perspective view diagram illustrating a second example of the fastener in operation.

FIGS. 3a-3h illustrate a process of assembling a first furniture assembly.

FIGS. 4a-4f illustrate a process of assembling a drawer unit of the first furniture assembly.

FIGS. 5a-5h illustrate a process of assembling a second furniture assembly.

FIGS. 6a-6g illustrate a process of assembling a third furniture assembly.

FIG. 7a is a perspective view diagram illustrating a second embodiment of a third fastener.

FIG. 7b is a front view of the third fastener.

### DETAILED DESCRIPTION

The invention will now be described in greater detail, by way of example, with reference to the drawings.

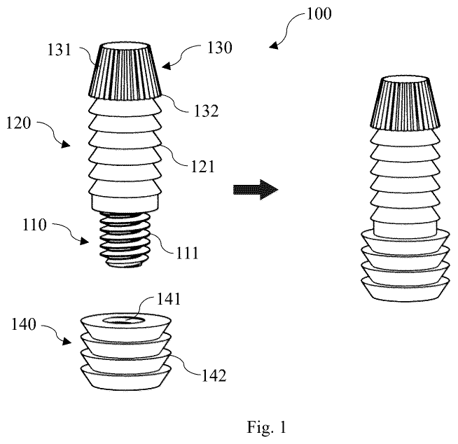

Referring to FIG. 1, a fastener 100 is illustrated. This fastener 100 is intended for connecting components of a furniture assembly 1 without requiring tools during assembly. Preferably, the fastener 100 comprises an elongated body, which is longitudinally divided into a first section 110, a second section 120, and a third section 130. The elongated body is generally cylindrical, but it should be understood that it can also have a polygonal cross-section. The sections 110, 120, 130 can be arranged sequentially, with the second section 120 positioned between the first and third sections 110, 130. The first section 110 extends from one end of the second section 120 and includes external threads 111 configured to be screwed into a threaded hole 11, 141 of a first component 10. The second section 120 comprises a plurality of serrated teeth 121 configured to firmly engage with a hole 21 in a second component 20. The third section 130 extends from an opposite end of the second section 120 and includes a frictional surface 131 that can be gripped by a user to facilitate the screwing motion of the first section 110 into the first component 10.

The first section 110 may alternatively be inserted into a nut 140 with a threaded hole 141. This nut 140 may have serrated teeth 142 on its outer surface, allowing it to be firmly inserted into a hole 11 of the first component 10. The second section 120, which includes the serrated teeth 121, can have a larger diameter than the first section 110 that includes the external threads 111. This configuration forms a step at the first end of the second section 120, acting as a stopper to prevent the second section 120 from entering the threaded hole 11, 141 of the first component 10. Alternatively, the first section 110 and the second section 120 are about the same diameter. The third section 130 can have a truncated cone shape with a ridged base 132 located adjacent to the second end of the second section 120. The ridged base 132 preferably functions similarly to the serrated teeth 121 of the second section 120, firmly engaging with the internal surface of the hole 21 of the second component 20. In this embodiment, the third section 130 can be inserted into the hole 21 of the second component 20 along with the second section 120. The third section 130 can have one or more corrugated external surfaces 131, providing a wavy or ribbed texture to enhance surface friction.

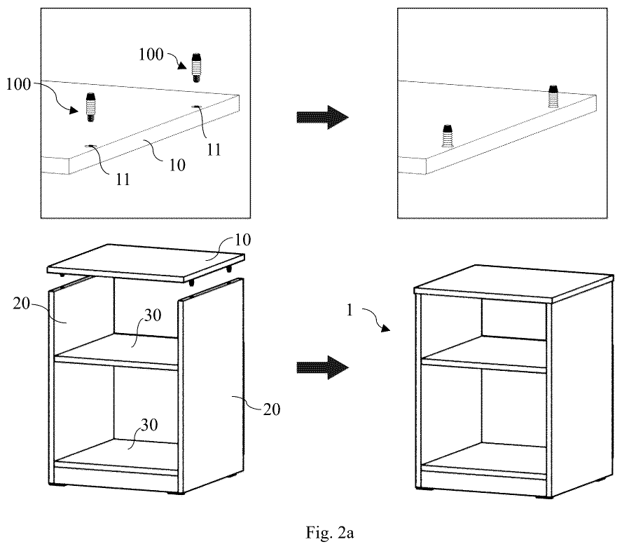

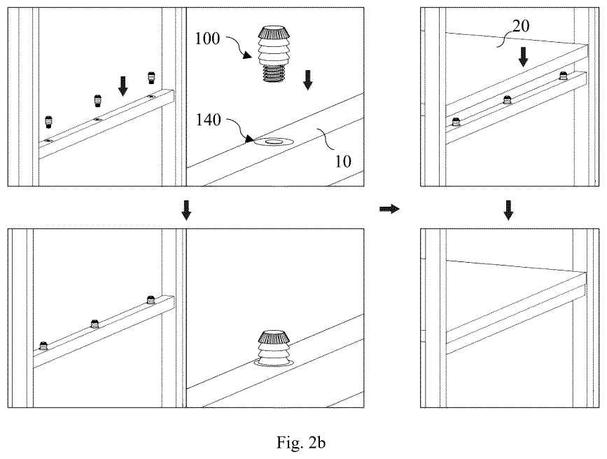

The components may include panels and/or frame structures made of metal, plastic, wood, or any combination thereof. FIG. 2a illustrates the use of one or more fasteners 100 to join two or more furniture panels 10, 20. The panels 10, 20 may be made from various wood materials, including but not limited to particleboard, medium-density fibreboard, plywood, solid wood, hardboard, melamine, and veneered wood. FIG. 2b illustrates the use of one or more fasteners 100 to join a panel 20 to one or more metal frames 10. Preferably, at least one of the panels or frames are attached with the nuts 140 for receiving the first section 110 of the fastener 100.

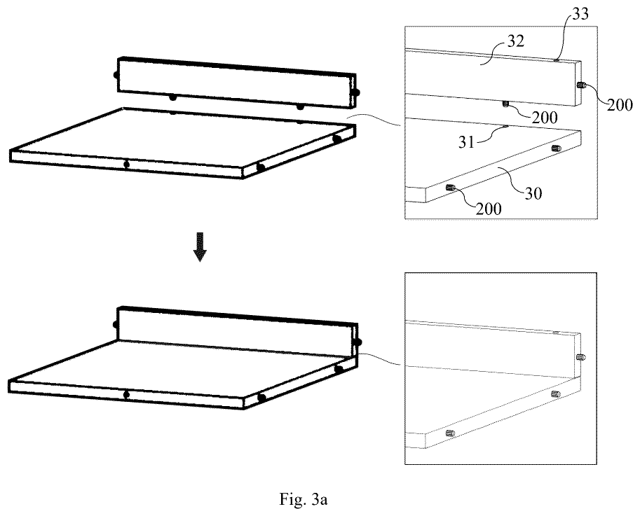

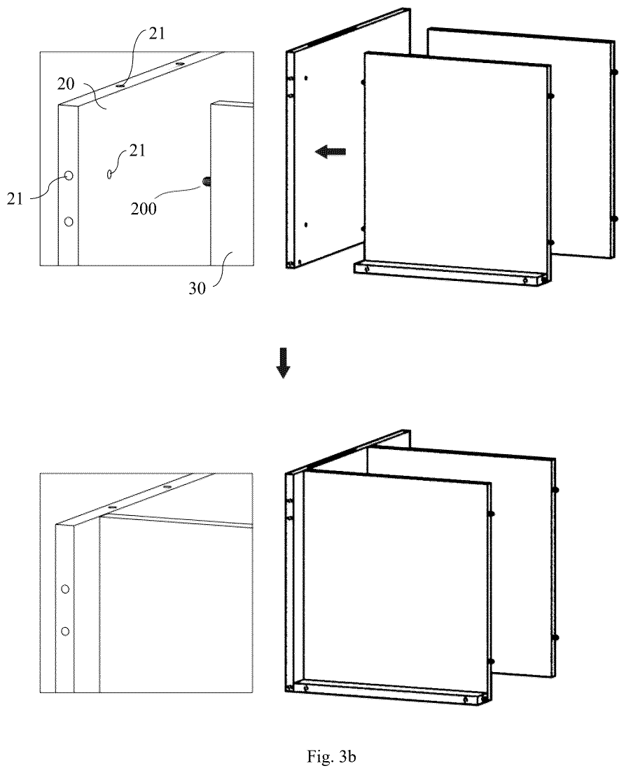

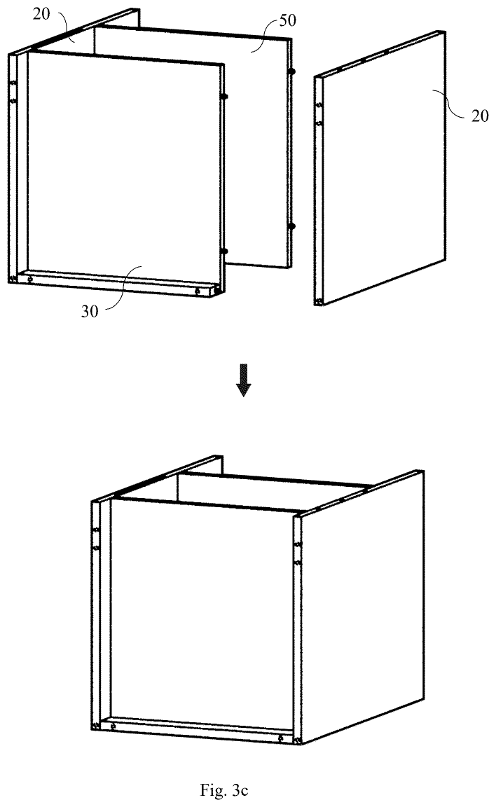

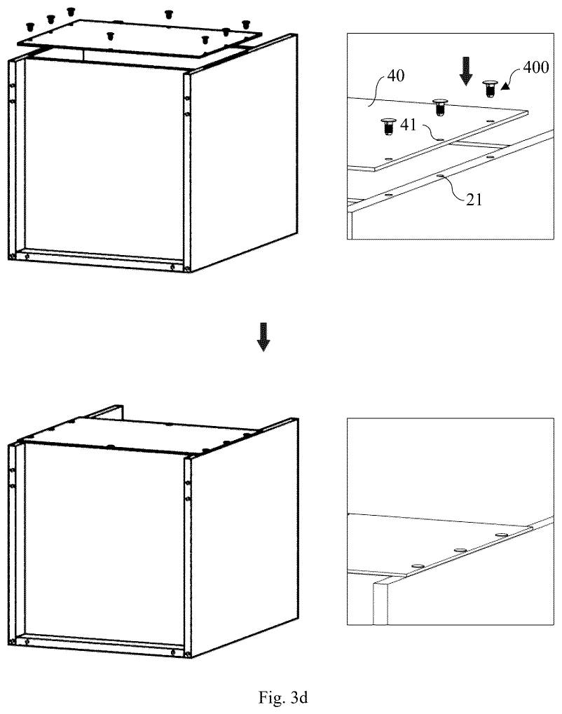

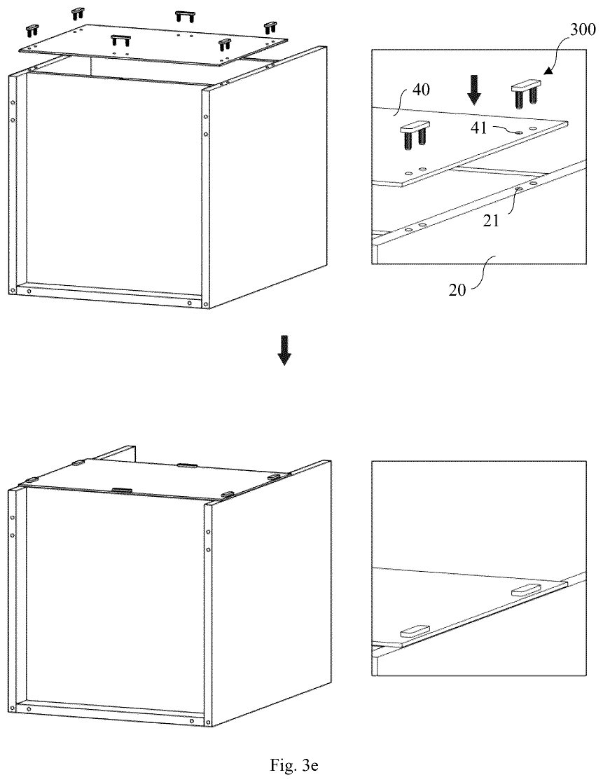

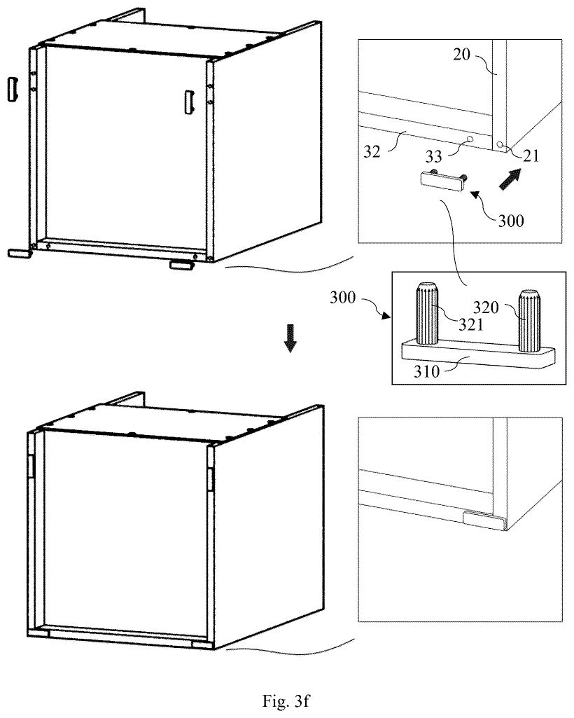

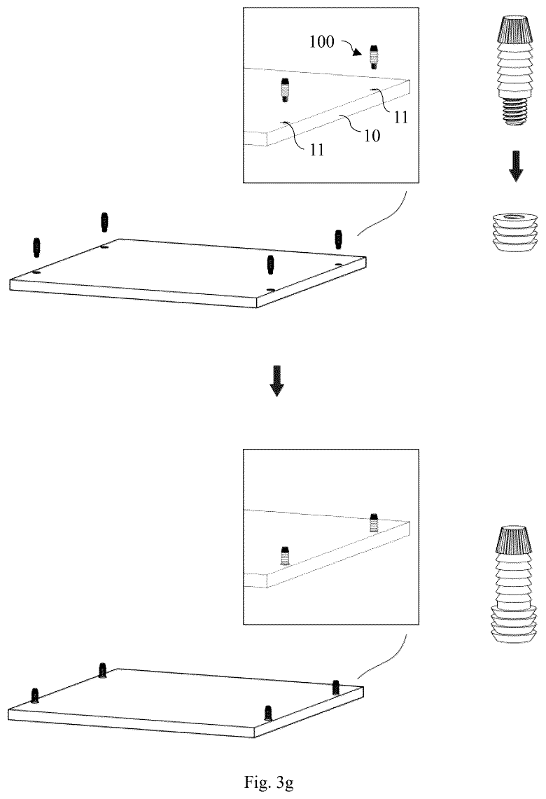

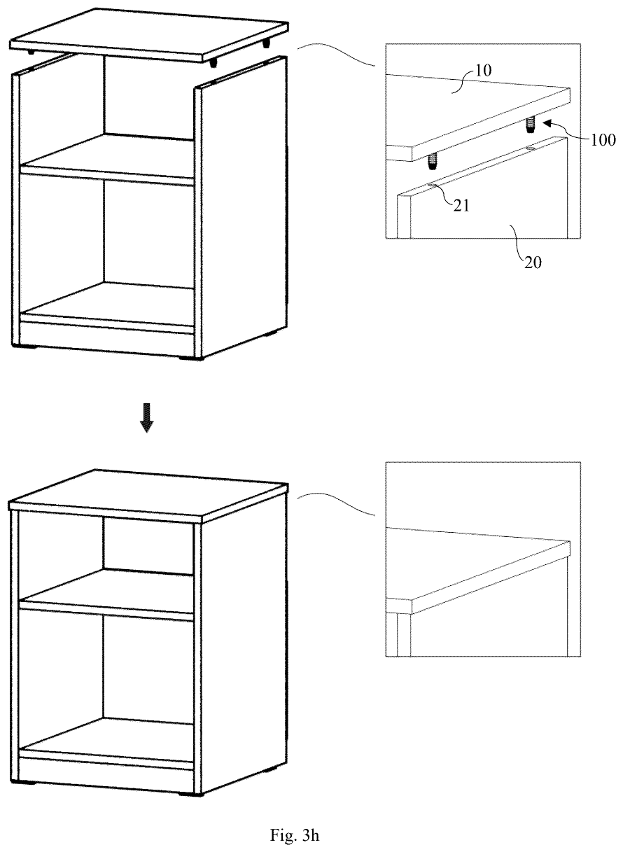

Referring to FIGS. 3a-3h, the process of assembling a first embodiment of the furniture assembly 1 is illustrated. The main structure of the furniture assembly 1 comprises a plurality of components including a top panel 10, a bottom panel 30, 32, a pair of side panels 20, one or more intermediate panels 50, and a rear panel 40. In the first step, two panels 30, 32 are joined using a plurality of second fasteners 200, forming an L-shaped bottom panel 30, 32. Preferably, the second fasteners 200 are dowel pins. The panels 30, 32 are pre-formed with holes 31 for the dowel pins to be fitted therein. In the second step, one edge of the bottom panel 30, 32 and one edge of an intermediate panel 50 are attached to a side of the first side panel 20 at a right angle via a plurality of second fasteners 200. In the third step, a second side panel 20 is attached to the opposing edges of the bottom panel 30, 32 and the intermediate panel 50 via a plurality of the second fasteners 200. In the fourth step, the rear panel 40 is attached to the edges of the side panels 20, the intermediate panel 50, and the bottom panel 30, 32 via a plurality of fourth fasteners 400. Preferably, each fourth fastener 400 includes a shaft body with a cap at one end of the shaft body and a plurality of teeth spaced along the shaft's longitudinal distance. Alternatively, the fourth fasteners 400 can be replaced by a plurality of third fasteners 300. Each third fastener 300 preferably includes a plate body 310 and a pair of projections 320, 321 extending from one side of the plate body 310 for insertion into holes in the panels. In the fifth step, the third fasteners 300 are used to secure the joints between the bottom panel 30, 32 and the side panels 20. Preferably, one projection 320 of the third fastener 300 is inserted into a hole 21 beneath the side panel 20, and the other projection 321 is inserted into a hole 33 beneath the bottom panel 30, 32. In this embodiment, the third fasteners 300 not only secure the joints but also act as leg supports for the furniture assembly 1. Further third fasteners 300 can be attached to the furniture assembly 1 to ensure the leg supports provide consistent levelling. In the sixth step, one or more fasteners 100 are inserted into the threaded holes 11, 141 of the top panel 10, ensuring that the second and third sections 120, 130 of the fasteners 100 remain exposed. In the final step, the top panel 10 is then secured to the side panels 20 by aligning and inserting the exposed sections 120, 130 of the fasteners 100 into the corresponding holes 21 at a top of the side panels 20. It should be noted that the use of second, third and fourth fasteners 200, 300, 400 in the different steps are interchangeable and they can be easily replaceable by other type of fasteners that are commercially available.

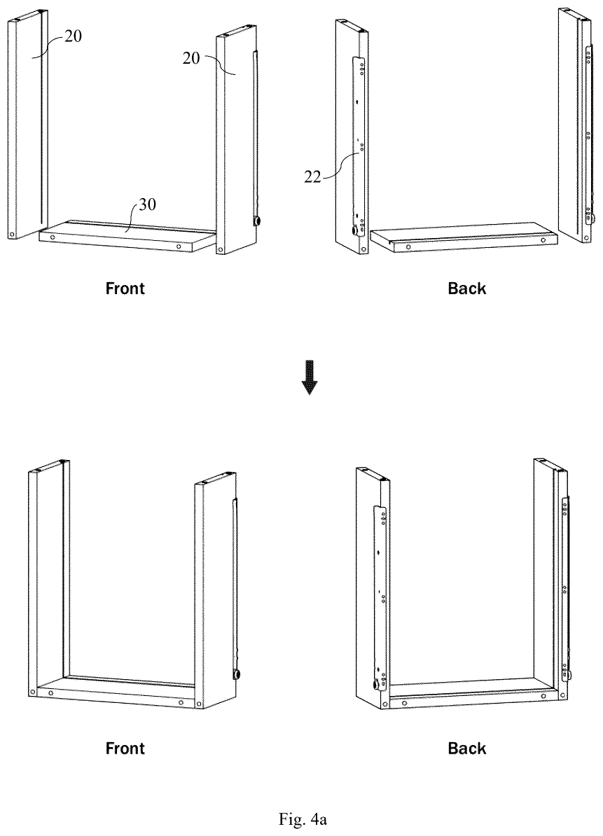

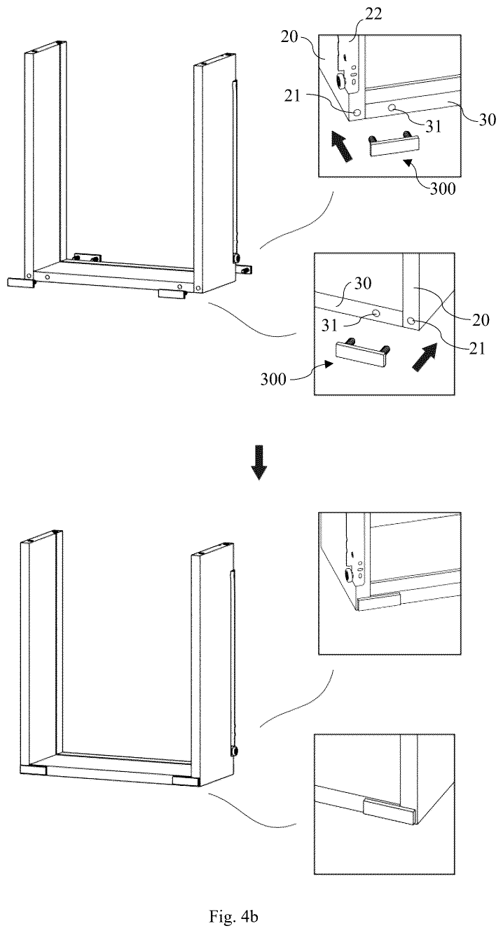

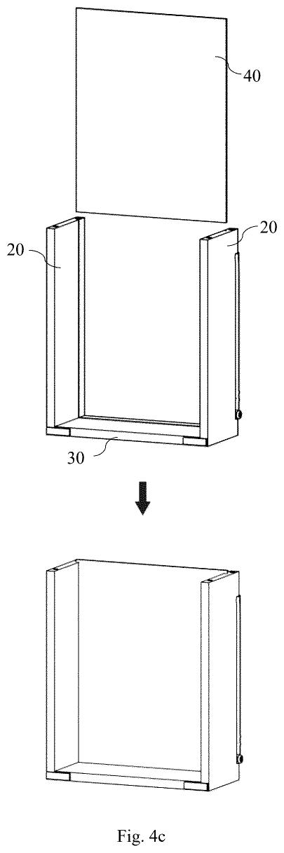

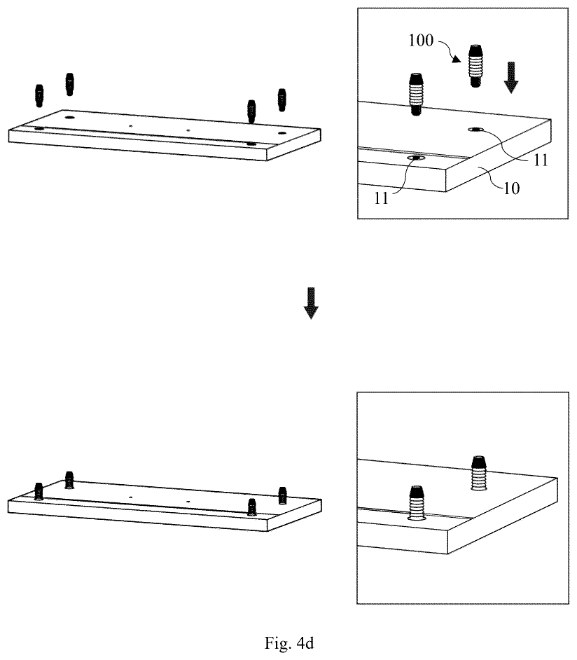

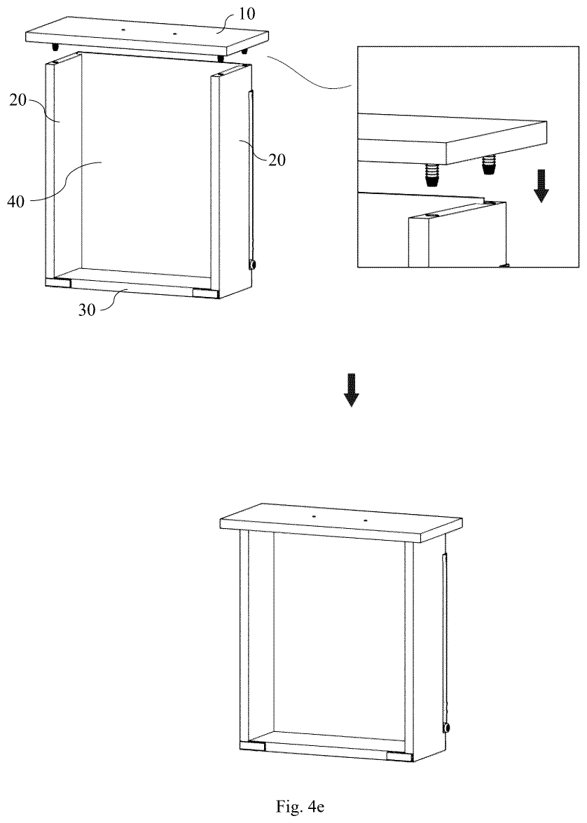

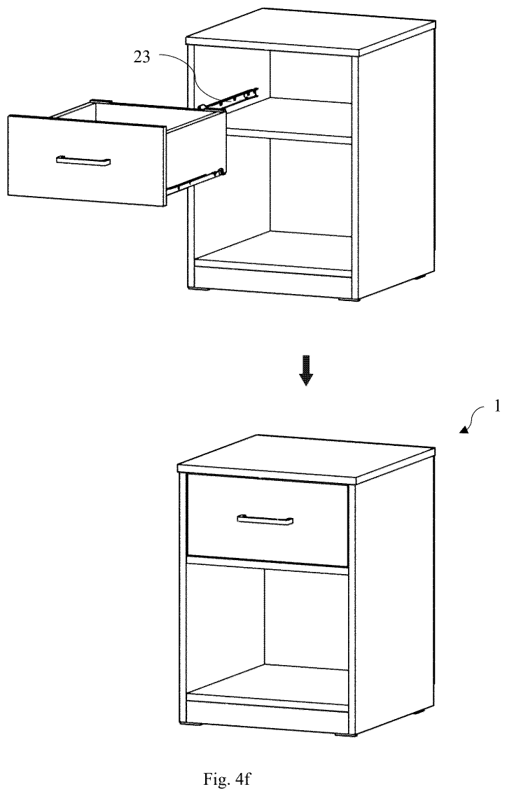

Referring to FIGS. 4a-4f, the process of assembling a drawer unit of the first embodiment of the furniture assembly 1 is illustrated. The main structure of the drawer unit comprises a plurality of components, including a front panel 10, a rear panel 30, a pair of side panels 20, and a bottom panel 40. A drawer slide mechanism is provided to enable the drawer unit to slide between an open position and a closed position. Preferably, the drawer slide mechanism includes a first member 22 attached to the side panels of the drawer unit and a second member 23 attached to the furniture assembly. The first and second members 22, 23 are configured to be engageably slidable relative to one another. In the first step, the side panels 20 are attached to the rear panel 30 at a right angle using the third fasteners 300. Preferably, both opposing edges of the side panels 20 and the rear panel 30 are securely fastened by the third fasteners 300. In the second step, the edges of the bottom panel 40 are slidably inserted into grooves of the side panels 20 and the rear panel 30. In the third step, one or more fasteners 100 are inserted into the threaded holes 11, 141 of the front panel 10, ensuring that the second and third sections 120, 130 of the fasteners 100 remain exposed. In the fourth step, the front panel 10 is then secured to the side panels 20 by aligning and inserting the exposed sections 120, 130 of the fasteners 100 into the corresponding holes 21 in the edges of the side panels 20 opposing to the rear panel 30. The front panel 10 may also have a groove to receive an edge of the bottom panel 40.

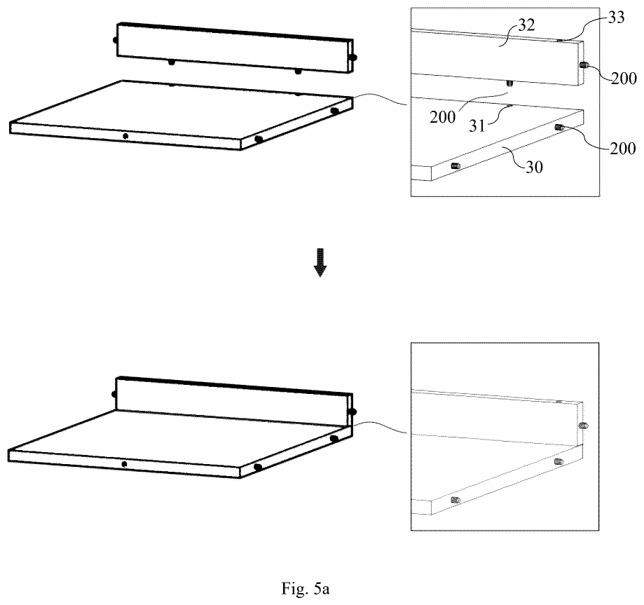

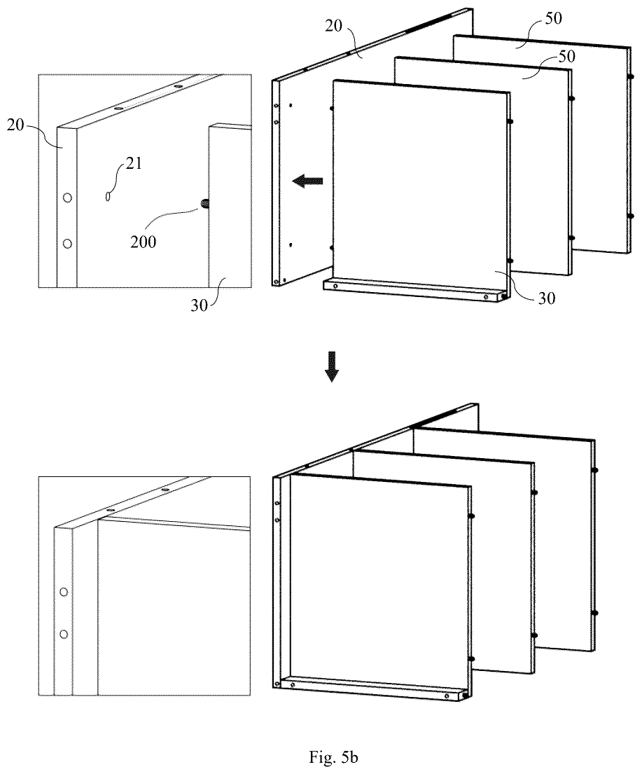

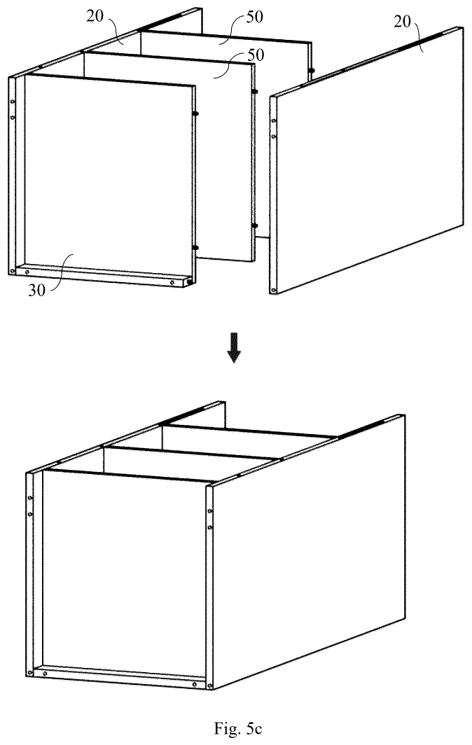

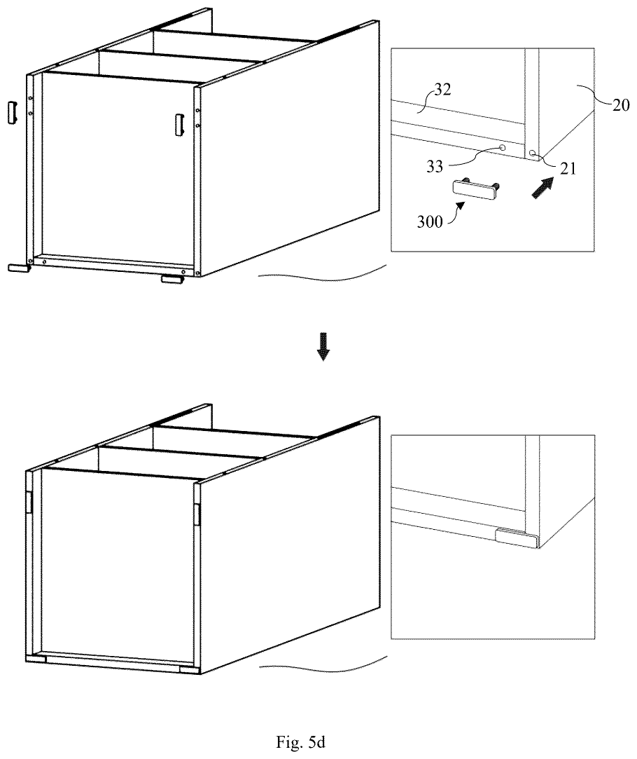

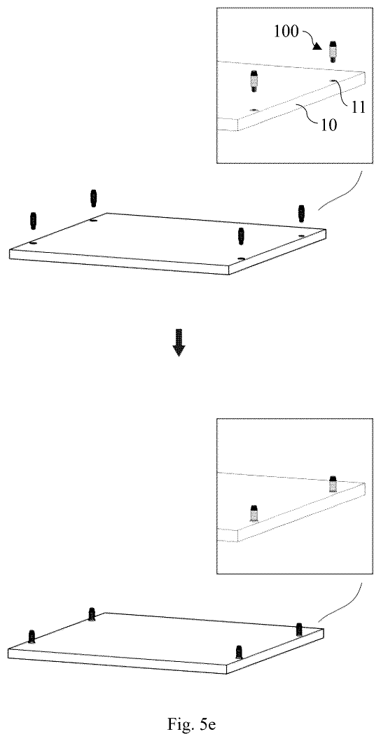

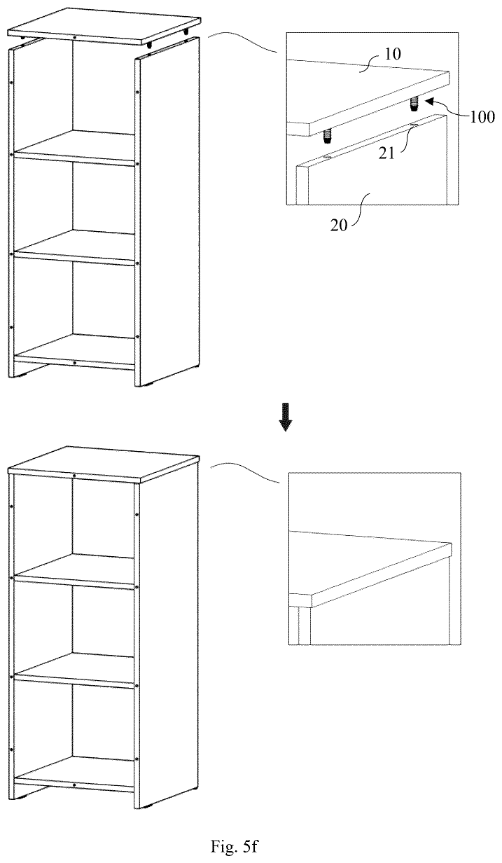

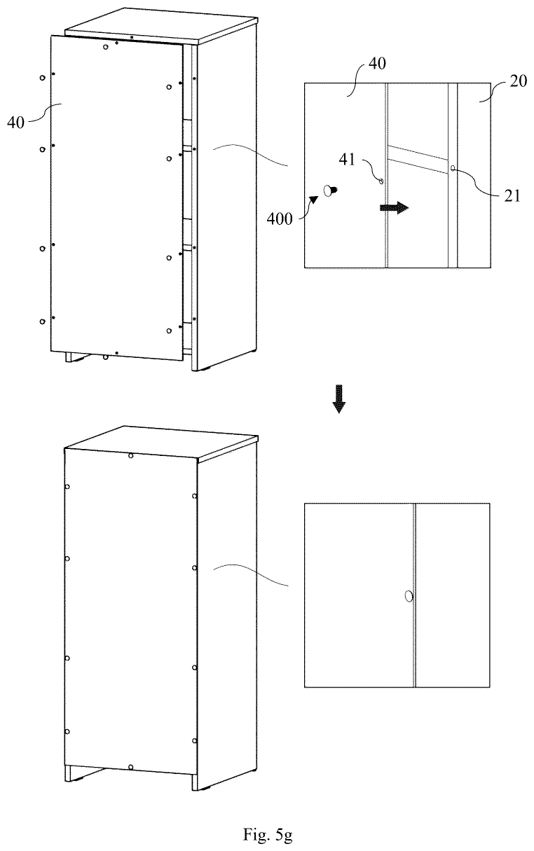

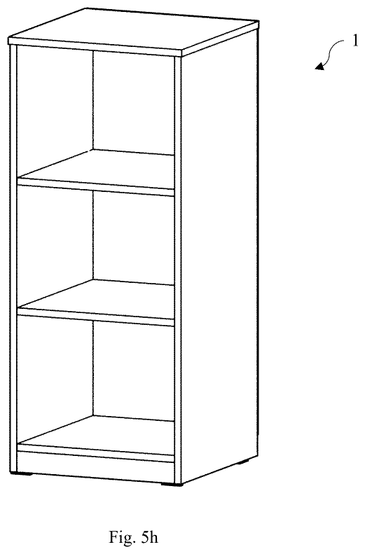

Referring to FIGS. 5a-5h, the process of assembling a second embodiment of the furniture assembly 1 is illustrated. The main structure of the furniture assembly 1 comprises a plurality of components including a top panel 10, a bottom panel 30, 32, a pair of side panels 20, a plurality of intermediate panels 50, and a rear panel 40. In the first step, two panels 30, 32 are joined using a plurality of second fasteners 200, forming an L-shaped bottom panel 30, 32. In the second step, one edge of the bottom panel 30, 32 and one edge of the intermediate panels 50 are attached to a side of the first side panel 20 at a right angle via a plurality of the second fasteners 200. In the third step, a second side panel 20 is attached to the opposing edges of the bottom panel 30, 32 and the intermediate panels 50 via a plurality of the second fasteners 200. In the fourth step, third fasteners 300 are used to secure the joints between the bottom panel 30, 32 and the side panels 20. Preferably, the third fasteners 300 are connected to the holes 21, 33 beneath the side panels 20 and the bottom panel 30. In the fifth step, one or more fasteners 100 are inserted into the threaded holes 11, 141 of the top panel 10, ensuring that the second and third sections 120, 130 of the fasteners 100 remain exposed. In the sixth step, the top panel 10 is then secured to the side panels 20 by aligning and inserting the exposed sections 120, 130 of the fasteners 100 into the corresponding holes 21 at a top of the side panels 20. In the final step, the rear panel 40 is attached to the edges of the side panels 20, the intermediate panel 50, the bottom panel 30, 32 and the top panel 10 via a plurality of the fourth fasteners 400.

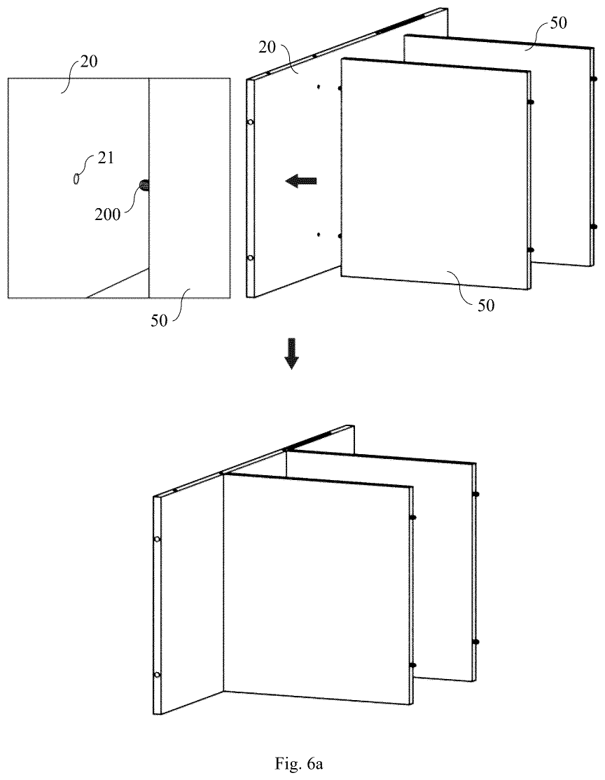

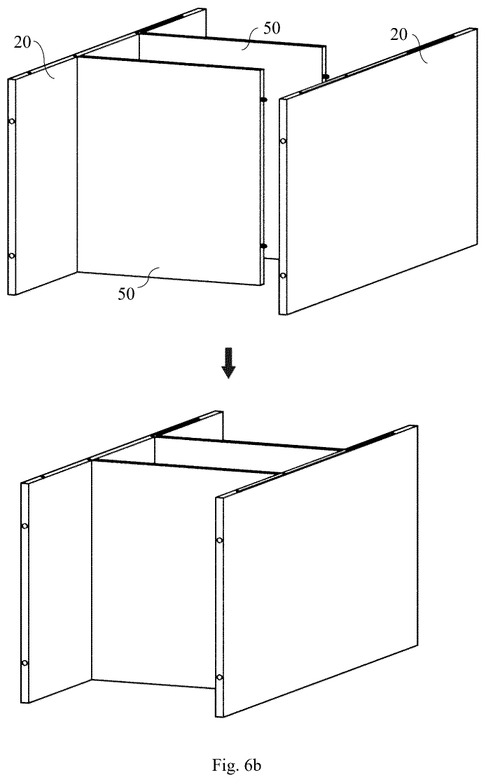

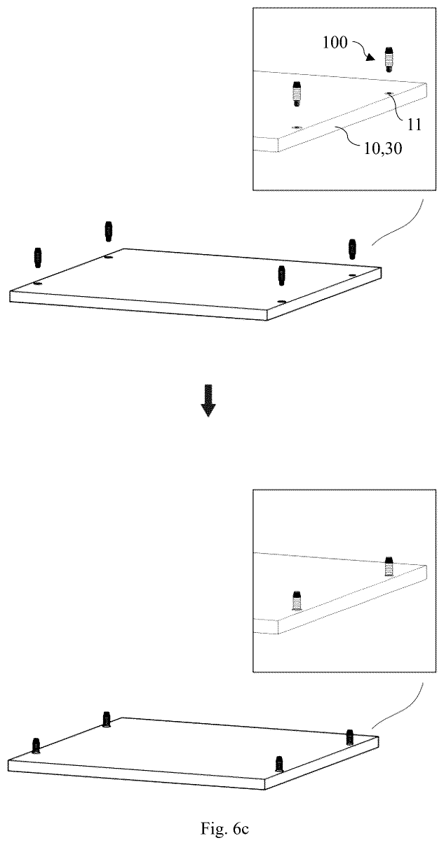

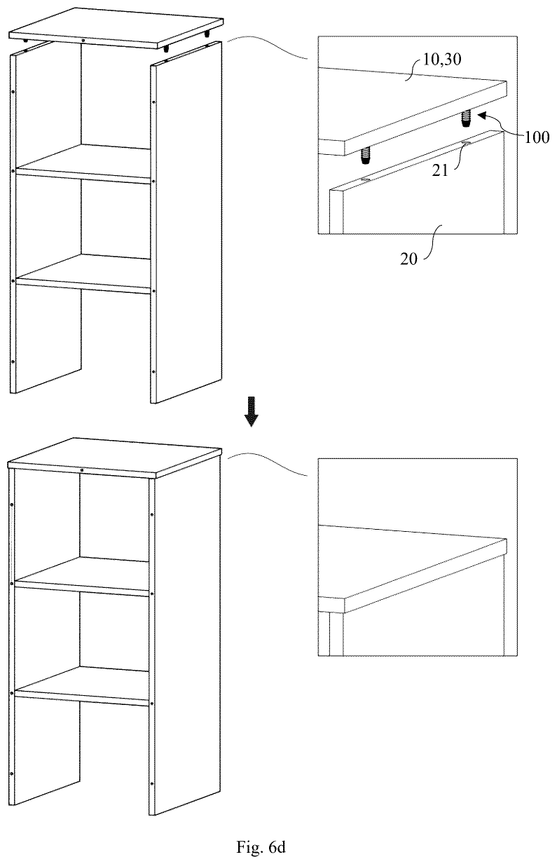

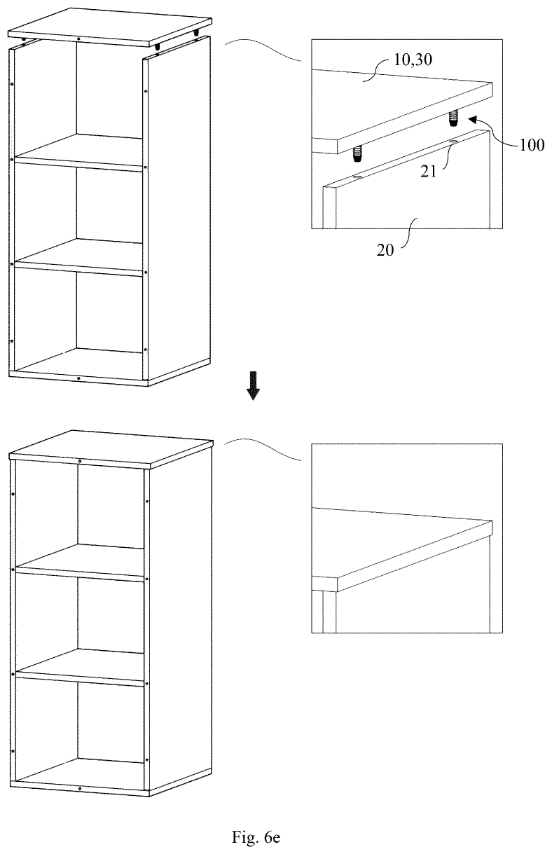

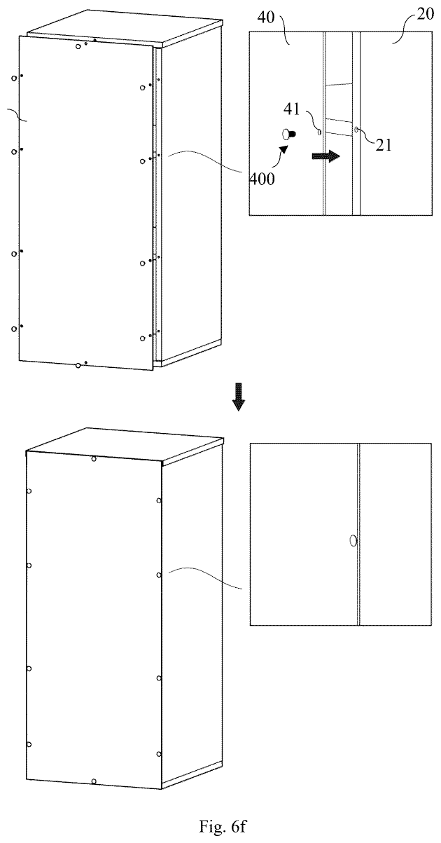

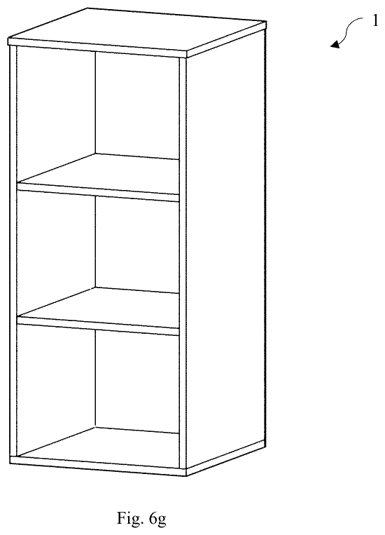

Referring to FIGS. 6a-6g, the process of assembling a third embodiment of the furniture assembly 1 is illustrated. The main structure of the furniture assembly 1 comprises a plurality of components including a top panel 10, a bottom panel 30, a pair of side panels 20, a plurality of intermediate panels 50, and a rear panel 40. In the first step, one edge of the intermediate panels 50 are attached to a side of the first side panel 20 at a right angle via a plurality of the second fasteners 200. In the second step, a second side panel 20 is attached to the opposing edges of the intermediate panels 50 via a plurality of the second fasteners 200. In the third step, one or more fasteners 100 are inserted into the threaded holes 11, 141 of the top panel 10 and the bottom panel 30, ensuring that the second and third sections 120, 130 of the fasteners 100 remain exposed. In the fourth and fifth step, the top panel 10 and/or the bottom panel 30 are then secured to the side panels 20 by aligning and inserting the exposed sections 120, 130 of the fasteners 100 into the corresponding holes 21 at a top or a bottom of the side panels 20. In the final step, the rear panel 40 is attached to the edges of the side panels 20, the intermediate panel 50, the bottom panel 30 and the top panel 10 via a plurality of the fourth fasteners 400.

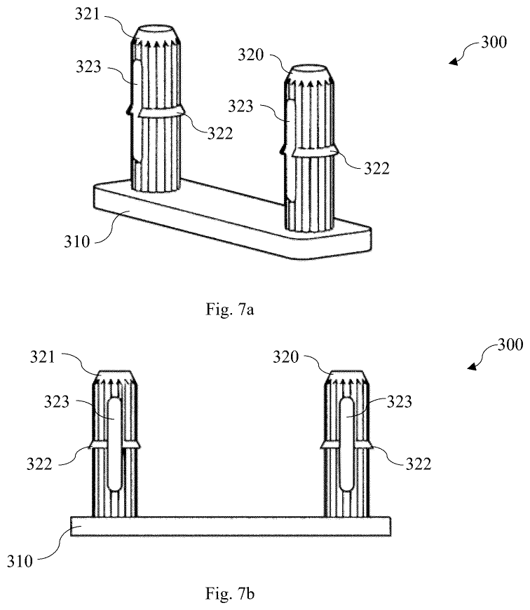

Referring to FIG. 7a & FIG. 7b, a second embodiment of the third fastener is illustrated. The third fastener 300 comprises a plate body 310 and a pair of projections 320, 321, which extend from one side of the plate body 310. Each projection 320, 321 includes a corrugated surface that provides a frictional grip for securing the insertion, at least one tooth flange 322 along a length of the projection 320, 321 to firmly engage the inner surface of the hole, and a slot 323, adjacent to the tooth flange 322, that allows a resilient deformation in the area where the tooth flange is located, thereby creating a return force that presses the tooth flange 322 against the inner surface of the hole. The size of the slot 323 determines the spring constant of the deformation during insertion. Specifically, a larger slot 323 size may result in lower spring constant, making the projection 320, 321 more flexible and easier to insert, while a smaller slot 323 size increases the spring constant, providing a stiffer resistance. Additional resilient material can be inserted into the hole to adjust the spring constant for different applications.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A fastener for use in connecting a plurality of components, the fastener comprising:
an elongate body having, in its longitudinal direction, a first section and a second section, the first section including external threads configured to be screwed into a threaded hole of a first component, and the second section including a plurality of serrated teeth configured to firmly engage with a hole of a second component.

2. The fastener according to claim 1, wherein the elongate body further includes a third section having a frictional surface configured to be gripped by a user to facilitate the screwing motion of the first section onto the first component.

3. The fastener according to claim 2, wherein a diameter of the second section is larger than or about the same as the first section.

4. The fastener according to claim 2, wherein the second section is positioned between the first and third sections.

5. The fastener according to claim 4, wherein the third section is inserted into the hole of the second component along with the second section.

6. The fastener according to claim 2, wherein the third section is of a truncated cone shape that has a ridged bas configured to firmly engage with the hole of the second component.

7. The fastener according to claim 2, wherein the threaded hole is in the form of a nut attached to the first component.

8. The fastener according to claim 2, wherein the components include panels and/or frame structures made of metal, plastic, wood or any combination thereof.

9. A furniture assembly comprising:
a first component; and
a second component connected to the first component via a fastener, the fastener including an elongate body having, in its longitudinal direction, a first section and a second section, the first section including external threads configured to be screwed into a threaded hole of a first component, and the second section including a plurality of serrated teeth configured to firmly engage with a hole of a second component.

10. The furniture assembly according to claim 9, wherein the elongate body further includes a third section having a frictional surface configured to be gripped by a user to facilitate the screwing motion of the first section onto the first component.

11. The furniture assembly according to claim 10, wherein a diameter of the second section is larger than or about the same as the first section.

12. The furniture assembly according to claim 10, wherein the second section is positioned between the first and third sections.

13. The furniture assembly according to claim 12, wherein the third section is inserted into the hole of the second component along with the second section.

14. The furniture assembly according to claim 10, wherein the third section is of a truncated cone shape that has a ridged base configured to firmly engage with the hole of the second component.

15. The furniture assembly according to claim 10, wherein the threaded hole is in the form of a nut attached to the first component.

16. The furniture assembly according to claim 10, further comprising a third component connected to the second component via one or more second fasteners and/or one or more third fasteners.

17. The furniture assembly according to claim 16, wherein the second fasteners are in the form of a dowel pin.

18. The furniture assembly according to claim 16, wherein each third fastener comprises:
a plate body; and
a pair of projections extending from one side of the plate body for insertion into holes of the second and third components respectively.

19. The furniture assembly according to claim 18, wherein each projection comprises at least one tooth flange along a length of the projection, and a slot adjacent to the tooth flange.

20. The furniture assembly according to claim 16, further comprising a fourth component connected to the first, second, and/or third components via a plurality of fourth fasteners.

21. The furniture assembly according to claim 20, wherein each fourth fastener comprises a shaft body with a cap at one end of the shaft body and a plurality of teeth space along a longitudinal distance of the shaft.
